(19) United States
(12) Patent Application Publication
(10) Pub. No.: US 2013/0094221 A1
(43) Pub. Date: Apr. 18, 2013

(54) Light Integrator for Rectangular Beam Cross Sections of Different Dimensions

(71) Applicants: Torsten Goletz, Jena (DE); Joerg-Peter Schmidt, Ichtershausen (DE); Jan Werschnik, Jena (DE)

(72) Inventors: Torsten Goletz, Jena (DE); Joerg-Peter Schmidt, Ichtershausen (DE); Jan Werschnik, Jena (DE)

(21) Appl. No.: 13/806,271

(22) PCT Filed: May 24, 2011
(86) PCT No.: PCT/DE11/50014

§ 371 Date: Dec. 21, 2012

(30) Foreign Application Priority Data
Jul. 1, 2010 (DE) 10-2010-026-252.8

(51) Int. Cl. G02B 27/09

(52) U.S. Cl. CPC G02B 27/0994
USPC 362/341

(57) ABSTRACT

A light integrator having four parallelepipedal glass plates which have an identical width. Each plate has an inner side and an outer side with a length, as well as a first and a second longitudinal side and two end faces with a height, the plates are arranged relative to one another such that they enclose a parallelepipedal open cavity extending over the length, the glass plates being bonded to one another. The inner sides of the plates are subdivided into, in each case, a mirror-coated, optically active surface and an adhesive surface, and the inner side bearing with its adhesive surface of in each case one glass plate indirectly via adhesive against the first longitudinal side of another glass plate. The inner side of said glass plates have a groove running in a longitudinal direction and acting as an adhesive trap adjoining the optically active surface. The inner side with its adhesive surface of in each case one glass plate bearing indirectly via adhesive against the first longitudinal side of another glass plate.

### RELATED APPLICATIONS

The present application is a U.S. National Stage application of International PCT Application No. PCT/DE2011/050014 filed on May 24, 2011 which claims priority benefit of German Application No. DE 10 2010 026 252.8 filed on Jul. 1, 2010, the contents of each are incorporated by reference in their entirety.

### FIELD OF THE INVENTION

The invention relates to a light integrator, which is configured as a hollow integrator and has a rectangular light exit face. Such a hollow integrator is known generically from the description of the prior art of US 2005/0213333 A1.

### BACKGROUND OF THE INVENTION

Light integrators find use wherever a particularly uniform illumination is desired. This can be the case, for example, in lithography, in wafer inspection or laser material processing. One example of equipment in which light integrators are used is projectors.

In principle, light integrators can be divided into those that guide light within a rod-shaped solid body which is either clad by a material with a higher refractive index or is provided with a mirror coating (rod or fiber integrators) and those that are formed by a tubular hollow body which is generally mirror-coated on the inner side (hollow integrators).

Rod or fiber integrators are primarily used for circular beam cross sections and have, compared to the hollow integrators, the disadvantage of higher light losses owing to absorption by the material guiding the radiation, which absorption cannot be completely avoided.

Hollow integrators are primarily used for angular beam cross sections, for example rectangular cross sections, and have, compared to the rod or fiber integrators, the disadvantage that they cannot be produced from one piece. Even if a hollow body that is necessary therefor were to be produced monolithically, no sufficiently uniform internal mirror-coating could be applied onto the inner side, which is why hollow integrators are in principle composed of at least two components.

In both types of light integrators, the radiation of a light bundle injected into a light entry face of the light integrator is homogenized with any desired energy distribution over the beam cross section, for example a Gaussian energy distribution, by multiple reflections inside the light integrator. The light bundle leaves the light integrator via a light exit face having a specific cross section geometry, such as circular or rectangular, with an at least nearly homogeneous energy distribution over the radiation cross section, what is referred to as a top-hat distribution. The aperture of the injected light bundle equals the aperture of the exiting light bundle.

### PRIOR ART

In US 2005/0213333 A1, the starting point is a prior art which is formed by a light integrator which comprises four flat glass plates which are joined together and together surround a parallelepipedal cavity. The glass plates in each case have a mirror-coated inner side, an outer side, two longitudinal sides and two end faces. The glass plates are arranged with respect to one another such that the mutually opposite glass plates form an inner and an outer glass plate pair. Here, the longitudinal sides of the inner glass plate pair bear against the inner sides of the outer glass plate pair such that the longitudinal sides of the inner glass plate pair project over the longitudinal sides of the outer glass plate pair. In order to form a hollow body with a rectangular cross section that deviates from a square cross section, the glass plates have different widths pair-wise.

The connection of the glass plates to one another is effected by adhesive strips, which are introduced in the notches formed by the longitudinal sides which are perpendicular to each other.

The applicant of US 2005/0213333 A1 is of the opinion that such a light integrator is disadvantageous owing to the configuration and arrangement of the glass plates with respect to one another and their exclusively integrally bonded connection. Such a light integrator could not absorb any forces and would be easily deformable.

In order to eliminate these disadvantages, the glass plates according to the subject matter of US 2005/0213333 A1 are configured as mutually paired components by cutouts and projections being formed in the longitudinal sides of the glass plates, which cutouts and projections correspond to one another and via which the glass plates are connected to one another, in addition to the integral bond, using the adhesive strips by way of a form fit.

Such a hollow integrator certainly has a higher stability, but its manufacture is more complex in particular because geometrically different glass plates are necessary rather than identical glass plates.

Both hollow integrators with rectangular cross section known from the prior art are composed of different glass plates, which is disadvantageous in terms of their manufacture. In addition, they are designed, with the dimensioning of the glass plates, for only one concrete cross section size of the light exit face.

### OBJECT OF THE INVENTION

The invention is based on the object of providing a stable hollow integrator that is simple to manufacture for forming a rectangular beam cross section which can be adapted for various cross section sizes.

This object is achieved for a light integrator as claimed in claim 1.

Advantageous embodiments are disclosed in the dependent claims.

### BRIEF DESCRIPTION OF THE DRAWINGS

The invention will be explained in more detail below using a drawing with reference to an exemplary embodiment. In the drawing:

FIG. 1a shows a light integrator in an exploded illustration

FIG. 1b shows a light integrator in a first mounting stage

FIG. 1c shows a light integrator in its final mounted state

FIG. 2a-2c shows a light integrator with different cavity widths y

### DESCRIPTION OF THE EMBODIMENTS

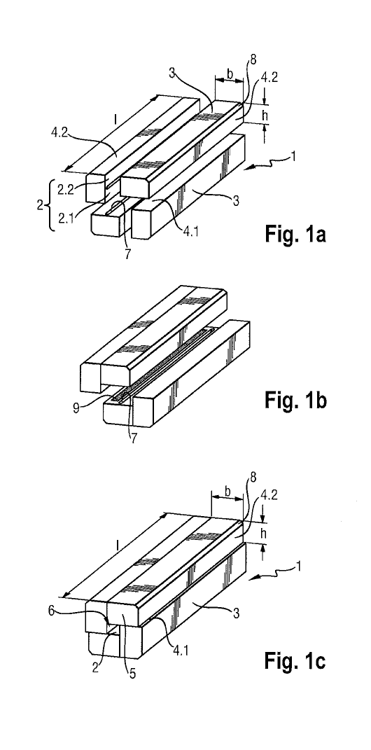

A light integrator according to the invention illustrated in FIGS. 1a to 1c comprises four identical, parallelepipedal glass plates 1. They have in each case an inner side 2 and an outer side 3, with a length l and a width b, and a first and a second longitudinal side 4.1, 4.2 and two end faces 5 with a height h. The inner sides 2 are subdivided into in each case a mirror-coated, optically active surface 2.1, and an adhesive surface 2.2, which includes a groove 7, which runs in a longitudinal direction and adjoins the optically active surface 2.1.

By producing all glass plates 1 as what is referred to as identical parts with a simple geometric shape, the manufacture complexity and thus the manufacturing costs can be kept low.

For the quality of the beam homogenization and the shaping of an exactly rectangular beam cross section of a light bundle that is guided through the light integrator, the quality of the optically active surface 2.1 and the perpendicularity between the inner sides 2 and the first longitudinal sides 4.1 are of critical importance.

The glass plates 1 must be checked in a 100% inspection after manufacturing. Owing to the high quality criteria (e.g. no outward protrusions on the inner sides 2, observed angle tolerances in each case between the first longitudinal side 4.1 and the inner side 2, and also a complete and homogeneous mirror-coating of the optically active surface 2.1), large quantities must be produced so that glass plates 1, which do not meet the quality criteria, can be rejected with an acceptable budget. By configuring the glass plates 1 as identical parts, it is possible for a maximum quantity to be produced in the same production process and using the same tools.

The glass plates 1 are arranged relative to one another such that they enclose a parallelepipedal open cavity 6 extending over the length 1, which open cavity is delimited by the optically active surfaces 2.1 of the inner sides 2. Here, the inner side 2 bears with its adhesive surface 2.2 in each case of a glass plate 1 indirectly via adhesive 9 against the first longitudinal side 4.1 of another glass plate 1. The cavity 6 has a cavity height x prescribed by the dimensioning of the glass plates 1, and a cavity width y which can be determined during mounting.

For mounting the light integrator, in a first mounting step, in each case two glass plates 1 forming an assembly are positioned relative to one another and bonded to one another, and, in a second mounting step, the two identical assemblies are positioned relative to one another and bonded to one another.

According to FIG. 1b, in each case two glass plates 1 forming an assembly are bonded to one another such that the outer side 3 of a glass plate 1 lies in a plane with the second longitudinal side 4.2 of another glass plate 1.

For the cavity 6 of the light integrator to be formed, the result is thus a cavity height x equal to the width b minus the height h.

The cavity width y is dependent on the direction in which the two assemblies are offset relative to one another and on the distance by which they are offset relative to one another when they are connected to one another, see e.g. FIG. 1c.

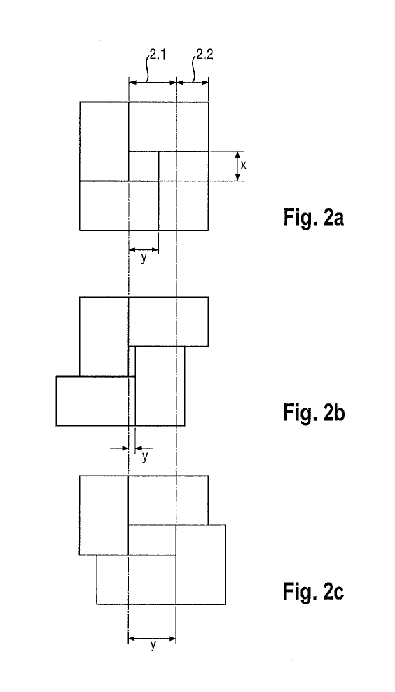

If the offset equals zero, the cavity width y is equal to the cavity height x, as shown in FIG. 2a. Owing to an offset of the assemblies relative to one another, the cavity width y can be reduced, see FIG. 2b, or increased, see FIG. 2c.

A maximum cavity width y is dependent owing to the position of the grooves 7, which adjoin the optically active surfaces 2.1. Thus, different cross section sizes with identical glass plates 1 can be realized by way of the variation of the cavity width y.

The grooves 7 serve as adhesive trap for adhesive 9, which is applied to the adhesive surfaces 2.2. By pressing excess adhesive 9 into the grooves 7 when the glass plates 1 are joined together, it is reliably ensured that the adhesive 9 passes onto the optically active surfaces 2.1. Since the adhesive surfaces 2.2 of a glass plate 1 coated with adhesive 9 in each case bear against the first longitudinal side 4.1 of another glass plate 1, the glass plates 1 are integrally bonded to one another via four forming adhesive strips.

Compared to the light integrators known from the prior art, the adhesive strips are not formed on the outer faces in an exposed manner but are encapsulated between the glass plates 1. This has the advantage that the adhesive 9 is completely enclosed by a same medium, in this case glass, and is subjected to hardly any temperature influences. Moreover, this has the advantage that the adhesive 9 is not exposed to any direct irradiation which can result in embrittlement of the adhesive 9. A light integrator according to the invention is therefore suitable particularly advantageously for uses in the UV range.

In order to attain a high stability of the light integrator, height h of the glass plates 1 is advantageously greater than half the width b and less than the width b.

Advantageously, in particular for mounting purposes, the glass plates 1 respectively have a chamfer 8 that extends over the entire length l of the glass plates 1, respectively over the edges formed by the outer side 3 and the second longitudinal side 4.2.

The chamfer 8 on the glass plates 1 firstly enables during mounting a simple differentiation in each case of the first longitudinal side 4.1 from the second longitudinal side 4.2, so as to reliably bond in each case the first longitudinal side 4.1.

Secondly, a functionally unnecessary sharp edge is thus eliminated, as is customary in optics components.

### List of the Reference Signs Used

1 glass plate
2 inner side
2.1 optically active surface
2.2 adhesive surface
3 outer side
4.1 first longitudinal side
4.2 second longitudinal side
5 end face
6 cavity
7 groove
8 chamfer
9 adhesive
l length of the glass plate
b width of the glass plate
h height of the glass plate
x cavity height
y cavity width

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed is:

1. A light integrator comprising four parallelepipedal glass plates which have an identical width, and having an inner side and an outer side with a length, as well as a first and a second longitudinal side and two end faces with a height, said plates being are arranged relative to one another such that they enclose a parallelepipedal open cavity extending over the length, the glass plates being bonded to one another, the inner sides being subdivided into in each case a mirror-coated, optically active surface and an adhesive surface, and the inner side bearing with its adhesive surface of in each case one glass plate indirectly via adhesive against the first longitudinal side of another glass plate, the inner side of said glass plates having a groove running in a longitudinal direction and acting as an adhesive trap, said groove adjoining the optically active surface, said inner side with its adhesive surface of in each case one glass plate bearing indirectly via adhesive against the first longitudinal side of another glass plate.

2. The light integrator as claimed in claim 1, wherein said cavity has a cavity height prescribed by the dimensioning of the glass plates, and a cavity width which can be determined during mounting.

3. The light integrator as claimed in claim 2, wherein in each case two glass plates forming an assembly are bonded to one another such that the outer side of a glass plate lies in a plane with the second longitudinal side of another glass plate.

4. The light integrator as claimed in claim 1, wherein the height of the glass plates is greater than half the width and less than the width.

5. The light integrator as claimed in claim 1, wherein the glass plates respectively have a chamfer that extends over the entire length of the glass plates, respectively over the edges formed by the outer side and the second longitudinal side.
